(19) United States
(12) Patent Application Publication
(10) Pub. No.: US 2006/0219815 A1
(43) Pub. Date: Oct. 5, 2006

(54) Nonlinear increasing bypass stator

(75) Inventor: Matthew R. Hekman, Yucaipa, CA (US)

Correspondence Address: INSKEEP INTELLECTUAL PROPERTY GROUP, INC, 2281 W. 190TH STREET, SUITE 200, TORRANCE, CA, 90504, US

(73) Assignee: The Toro Company

(21) Appl. No.: 11/100,094

(22) Filed: Apr. 5, 2005

(51) Int. Cl. B05B 15/10; B05B 1/32; B05B 1/30

(52) U.S. Cl. 239/451; 239/569; 239/204; 239/205

(57) ABSTRACT

The present invention provides an improved bypass stator that provides more consistent water flow to a sprinkler turbine and thus allows the sprinkler nozzle base to rotate with greater regularity. In one preferred embodiment, a crowned stator plunger is located on a sprinkler bypass valve. The scalloped protrusions of the stator plunger can be shaped to allow incrementally increasing amounts of water into the bypass passageway, thus compensating for a spring constant of a bypass valve spring.

### BACKGROUND OF THE INVENTION

The present invention relates to sprinklers and more specifically pertains to an improved stator design for regulating a bypass valve of a sprinkler.

Sprinkler systems for turf irrigation are well known. Typical systems include a plurality of valves and sprinkler heads in fluid communication with a water source, and a centralized controller connected to the water valves. At appropriate times the controller opens the normally closed valves to allow water to flow from the water source to the sprinkler heads. Water then issues from the sprinkler heads in a predetermined fashion.

There are many different types of sprinkler heads, including above-the-ground heads and “pop-up” heads. Pop-up sprinklers, though generally more complicated and expensive than other types of sprinklers, are typically thought to be superior. There are several reasons for this. For example, a pop-up sprinkler's nozzle opening is typically covered when the sprinkler is not in use and is therefore less likely to be partially or completely plugged by debris or insects. Also, when not being used, a pop-up sprinkler is entirely below the turf surface and thus generally less obtrusive to the landscape.

The typical pop-up sprinkler head includes a stationary body and a “riser” which extends vertically upward, or “pops up” when water is allowed to flow to the sprinkler. Typically, the riser is a hollow tube which supports a nozzle at its upper end. When the normally-closed valve associated with a sprinkler opens to allow water to flow to the sprinkler, two things happen: (i) water pressure pushes against the riser to move it from its retracted to its fully extended position, and (ii) water flows axially upward through the riser, and the nozzle receives the axial flow from the riser and turns it radially to create a radial stream. A spring or other type of resilient element is interposed between the body and the riser to continuously urge the riser toward its retracted, subsurface, position, so that when water pressure is removed, the riser will immediately proceed from its extended to its retracted position.

The riser of a pop-up or above-the-ground sprinkler head can remain rotationally stationary or can include a portion that rotates in continuous or oscillatory fashion to water a circular or partly circular area, respectively. More specifically, the riser of the typical rotary sprinkler includes a first portion, which does not rotate, and a second portion, which rotates relative to the first (non-rotating) portion.

The rotating portion of a rotary sprinkler riser typically carries a nozzle at its uppermost end. The nozzle throws at least one water stream outwardly to one side of the nozzle assembly. As the nozzle assembly rotates, the water stream travels or sweeps over the ground.

The non-rotating portion of a rotary sprinkler riser typically includes a drive mechanism for rotating the nozzle. The drive mechanism generally includes a turbine and a transmission. The turbine is usually made with a series of angular vanes on a central rotating shaft that is actuated by a flow of fluid subject to pressure. The transmission consists of a reduction gear train that converts rotation of the turbine to rotation of the nozzle assembly at a speed slower than the speed of rotation of the turbine.

During use, as the initial inrush and pressurization of water enters the riser, it strikes against the vanes of the turbine causing rotation of the turbine and, in particular, the turbine shaft. Rotation of the turbine shaft, which extends into the drive housing, drives the reduction gear train that causes rotation of an output shaft located at the other end of the drive housing. Because the output shaft is attached to the nozzle assembly, the nozzle assembly is thereby rotated, but at a reduced speed that is determined by the amount of the reduction provided by the reduction gear train. An example of a nozzle assembly having this design can be seen in U.S. Pat. No. 4,681,260, which is herein incorporated by reference in its entirety.

With such sprinkler systems, a wide variation in fluid flow out of the nozzle can be obtained. If the system is subject to an increase in fluid flow rate through the riser, the speed of nozzle rotation increases proportionally due to the increased water velocity directed at the vanes of the turbine. In general, increases or decreases in nozzle speed then, of course, affect the desired water distribution.

Prior art sprinklers have attempted to regulate the turbine speed by providing two water paths, one path leading to the turbine and another path bypassing the turbine when the pressure reaches a certain value. In typical designs of this type, pressure actuated valves divert a portion of the water around the turbine after a certain threshold pressure is reached in an attempt to reduce the flow hitting the turbine, as seen, for example, in U.S. Pat. Nos. 5,375,768 and 4,681,260, the contents of which are hereby incorporated by reference.

While the use of pressure actuated diversion valves within a sprinkler help regulate the water flow to the turbine, most such valves do not allow a proportionally consistent amount of water to bypass the turbine. This results in an undesirable variation in the amount and pressure of water reaching the turbine, thereby ultimately causing the sprinkler head to rotate at inconsistent speeds, particularly as water flow increases.

Such an undesirable quality is primarily due to the spring configuration within the diversion valve. In a typical design, the spring initially prevents the bypass valve from opening until a certain threshold water pressure is reached. However, after the threshold pressure is reached and the pressure continues to increase, further compression of the spring will be governed by the spring constant of the spring. Since the spring force will increase as the spring is compressed, there is corresponding increasing governance effect on the water flow that then affects the delivery of the water through the turbine.

In view of the foregoing problem, there is a need for an improved diversion valve regulation device. In particular, there is a need for a diversion valve that provides a substantially constant amount of water to the turbine by compensating for the increasing spring force.

### OBJECTS AND SUMMARY OF THE INVENTION

In light of the foregoing, it is an object of the present invention to overcome the limitations of the prior art.

It is another object of the present invention to provide a stator assembly that better regulates the rotation of a sprinkler head.

It is another object of the present invention to provide a stator assembly that causes the sprinkler head rotation speed to remain relatively constant despite increasing water flow into the sprinkler.

It is a further object of the present invention to provide a sprinkler stator bypass valve that diverts water that creates a relatively constant water flow against the sprinkler turbine.

The present invention attempts to achieve these objects, in one embodiment, by providing a stator plunger in the bypass valve with scalloped protrusions. The scalloped protrusions of the stator plunger can be shaped to allow exponentially increasing amounts of water into the bypass passageway, thus compensating for the increasing compression force of the bypass valve spring.

### BRIEF DESCRIPTION OF THE DRAWINGS

FIG. 1 illustrates a partial cross-sectional side view of a sprinkler according to the present invention;

FIG. 2 illustrates a partial cross-sectional perspective view of the sprinkler of FIG. 1;

FIG. 3A illustrates a perspective view of the stator of FIG. 1 in an open position;

FIG. 3B illustrates a perspective view of the stator of FIG. 1 in a closed position;

FIG. 4A illustrates a cross-sectional side view of a stator assembly according to the present invention;

FIG. 4B illustrates a cross-sectional side view of the stator assembly of FIG. 4A;

FIG. 4C illustrates a magnified cross-sectional side view of the stator assembly of FIG. 4B;

FIG. 5 illustrates an exploded perspective view of the stator of FIG. 4A; and

FIGS. 6A and 6B illustrate comparative sample flow data according to the present invention.

### DETAILED DESCRIPTION OF THE INVENTION

Generally, a turbine of a sprinkler is positioned on one side over a stator while being coupled on the other side to a rotational transmission responsible for causing the sprinkler head to rotate. As water enters the sprinkler, the stator directs the water to the turbine, causing the turbine to rotate. Thus, the turning turbine drives the sprinkler transmission and the rotating sprinkler head. An example of such an arrangement is shown and discussed in U.S. Pat. Nos. 5,720,435 and 5,375,768, both of which are incorporated herein by reference. Since turf irrigation highly prefers constant rotational velocity of the sprinkler head, it remains important to regulate the rotational speed of the turbine.

Prior art sprinklers have relied on various stator designs in an attempt to regulate turbine speed. However, such prior art designs typically did not uniformly control the rotation speed of the turbine over a wide range of in fluid flow.

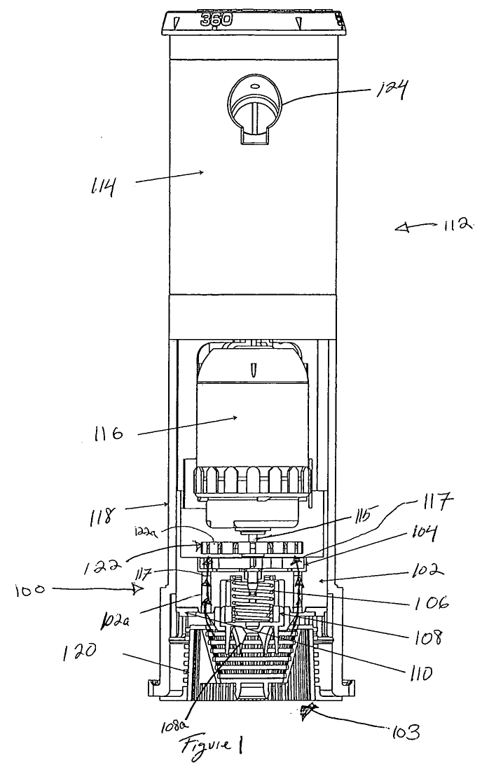

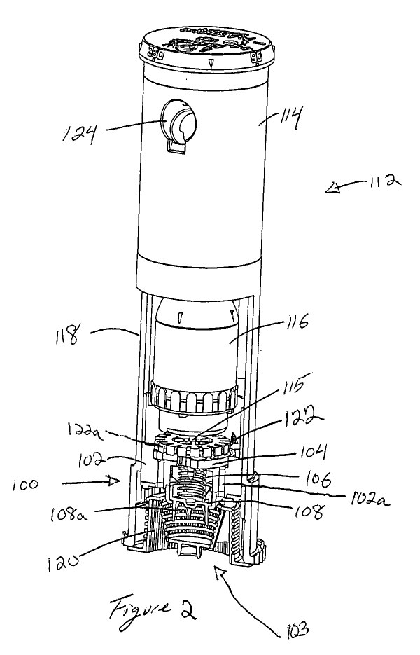

Looking to FIGS. 1 and 2, a sprinkler 112 having a nonlinear increasing bypass stator 100 according to the present invention is illustrated. The sprinkler 112 includes an inlet 103 through which water is introduced to a screen 120. The water is channeled from the screen 120 through a stator housing 102. A flow director 104 selectively directs the water in either a clockwise or counter clockwise direction to a turbine 122.

The turbine 122 is disposed on a drive shaft 115 which is coupled to reduction gears (not shown) within gear assembly 116. The gear assembly 116 is mounted within a sprinkler riser 118 and is also coupled to a sprinkler base 114. Thus, as the turbine 122 rotates, it drives the gears of the gear assembly 116 and ultimately the nozzle base 114, allowing the nozzle 124 to distribute water in an arc or full circle pattern.

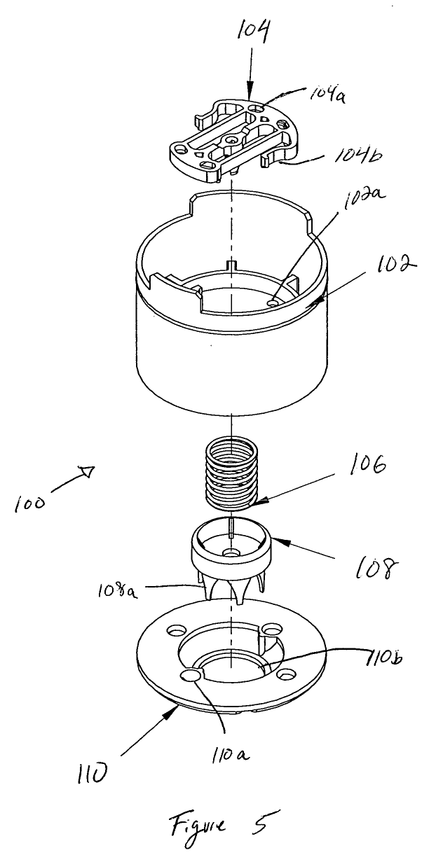

As best seen in FIGS. 1-5, a preferred embodiment of the non-linear increasing bypass stator 100 includes a stator plunger 108, having multiple scalloped protrusions 108a which, as explained in detail below, allow increasingly greater amounts of water through the stator 100 to compensate for undesirable compression characteristics of a valve spring 106.

The stator plunger 108 is positioned within a stator housing 102 and biased to a closed position by the valve spring 106. In a closed position, the stator plunger 108 seats against a lower stator cover 110, preventing water from flowing through side channels of the stator housing 102 and around the turbine 122.

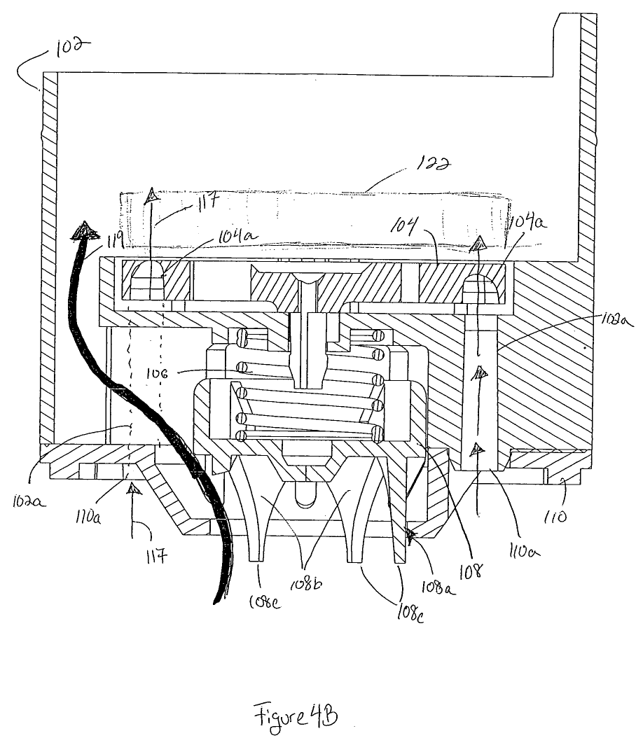

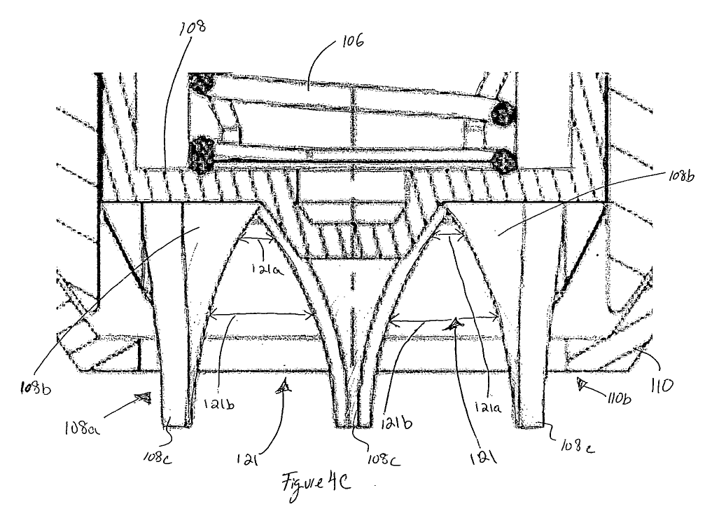

The stator 100 includes two flow paths: a main flow path 117 (seen in FIGS. 1, 4A and 4B) directed toward blades 122a on the outer circumference of the turbine 122 and a bypass flow path 119 (seen in FIG. 4B) around the outside of the turbine 122 to avoid the turbine blades 122a. The main flow path 117 directs water flow through apertures 110a in the stator cover 110 and on to flow passages 102a in the stator housing 102. As the water exits the stator housing 102, directing apertures 104a of the flow director 104 direct the water flow against the turbine 122.

The flow director 104 can move between two positions, causing the water flow through the directing apertures 104a to contact the turbine 122 at one of two angles and therefore cause rotation of the turbine 122 in one of two directions. The molded arms 104b act as an over-center spring, creating pressure against the stator housing 102 to ensure the flow director 104 is “snapped” into either of its two positions at all times.

The flow director 104 is moved between each of the two flow positions by a trip shaft (not shown) which passes from the nozzle base 114, through the center of the drive assembly 116 and is ultimately coupled to the center of the flow director 104. This design allows a slight rotation of the trip shaft to move the flow director 104 to its alternate position, changing the direction of water flow against the turbine 122 and consequently selectively reversing rotational direction of the nozzle base 114. An example of such a flow director 104 can be seen in U.S. patent application Ser. No. 10/797,436 filed Mar. 10, 2004 entitled Adjustable Arc Sprinkler With Full Circle Operation, the entire contents of which are incorporated by reference.

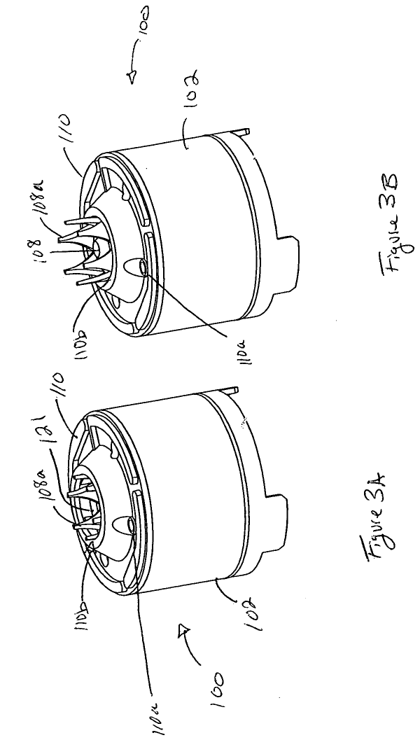

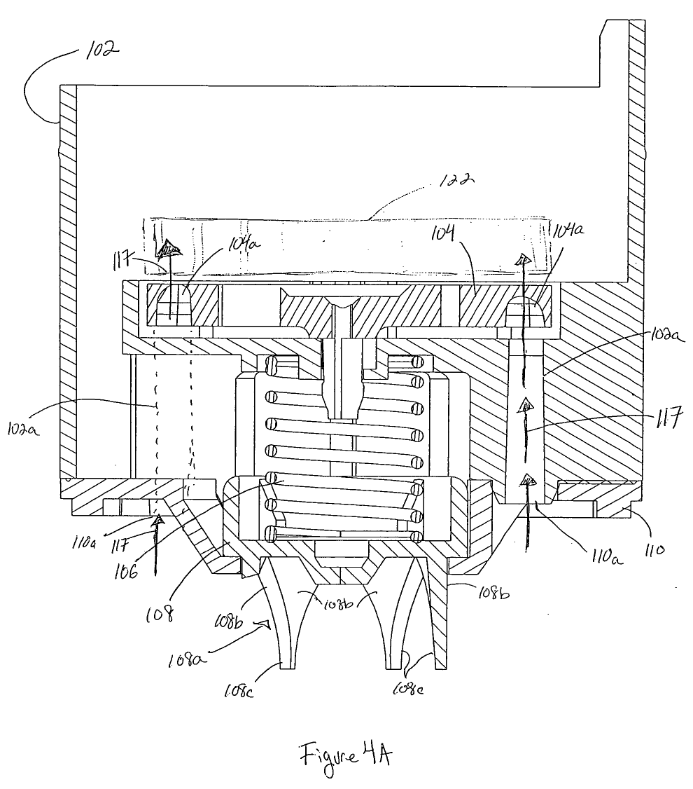

As previously mentioned, the stator 100 includes a bypass flow path 119 (seen best in FIG. 4B) through the outer circumferential area of the stator housing 102 which when open to flow, prevents that water from contacting the outer blades 122a of the turbine 122. This bypass flow path 119 is only available to water entering the sprinkler 112 when the water pressure below the stator 112 increases above a certain threshold level. This threshold level is determined by the amount of pressure applied by the stator spring 106 against the stator plunger 108. When the water pressure from the water flow becomes greater than the pressure applied by the stator spring 106, the stator plunger 108 opens, moving away from the stator cover 110. The open position can best be seen in FIG. 3A while the closed position can best be seen in FIG. 3B.

The stator spring 106 is characterized by a spring constant that requires increasing amounts of force for each additional increment the spring is compressed. For example, a stator spring may be 1.5 inches in length in its uncompressed state. Compressing this spring to 0.52 inches may require force of 2.4 lbf, but compressing the spring to 0.35 inches may require an incremental increase in force of 0.5 lbf, i.e. a total force of 2.9 lbf. In short, the force to compress the spring increases as compression increases. Although this force-to-compression ratio may vary between springs, most (if not all) springs are characterized by such an increasing ratio. It is known as a spring's “spring constant”.

In one preferred embodiment, the present invention compensates for this characteristic of the stator spring 106 with the inclusion of a plurality of scalloped protrusions 108a on the stator plunger 108. The scalloped protrusions 108a serve to variably control the bypass flow of water through the bypass path of the stator 100 based on the amount of depression of the stator plunger 108.

As seen best in FIGS. 4A-4C, the scalloped protrusions 108a have a relatively wide base 108b that decrease in width to a tip 108c as the protrusion 108a extends away from the surface of the stator valve 108. The configuration of the scalloped protrusions 108a may also be described as forming curved oblong openings 121 (best seen in FIG. 4C) between each protrusion 108a. These oblong openings 121 have a narrow region 121a adjacent the base surface of the stator valve 108 that then progressively increase in size to a wide region 121b as the protrusions 108a extend away from the base surface of the stator valve 108. The scalloped protrusions 108a extend through the center opening of the stator cover 110. Preferably, the scalloped protrusions 108a are positioned near the edge of the stator valve 108 and are curved to match the circular shape of the stator valve 108.

As the flow of water begins to depress the stator valve 108, the base 108b of each scalloped protrusion 108a blocks a large portion of the water from passing through the center aperture 110b of the stator cover 110. Or in other words, as the stator valve 108 opens, water is initially only allowed into the center aperture 110b through the narrow regions 121a of each oblong openings 121. Then, as water pressure on the stator valve 108 increases and the stator valve 108 is further depressed, the water will be exposed to larger regions of the oblong openings 121, thus allowing greater amounts of water to bypass the turbine 122 through the center aperture 110b. When the stator valve 108 is fully depressed (highest pressure), the water will then be exposed to the full size of each oblong opening 121, thus allowing the maximum amount of bypass flow. In short, the oblong openings 121 are shaped so that they expose the flow to greater surface area as the stator valve 108 moves upward. In this sense the stator valve 108 is non linear.

In this manner, the stator valve 108 is able to govern the amount of flow bypassing the turbine in a manner that substantially negates the undesirable effects of the spring constant of the stator spring 106. That is, by minimizing the amount of bypass flow when the water pressure is near the threshold bypass pressure and maximizing the bypass flow when the water pressure is highest, the stator valve 108 as configured with the scalloped protrusions 108a and oblong openings 121 provide substantial compensation for the effect of the increasing spring force (spring constant) of the stator spring 106. As a result, the speed of the rotating nozzle of the sprinkler is far less susceptible to speed fluctuations.

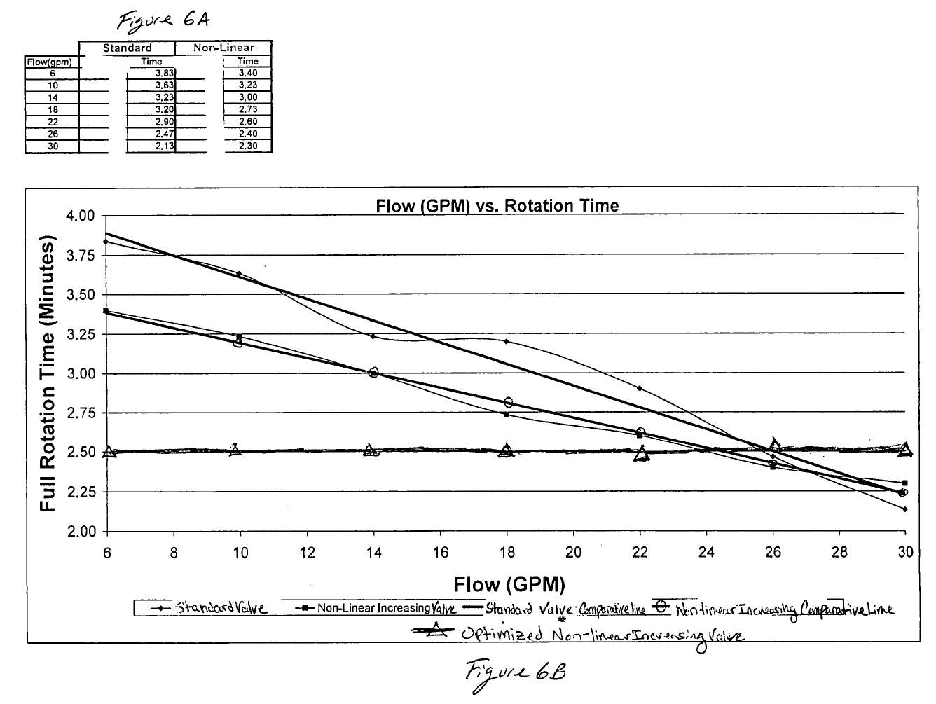

FIG. 6A illustrates example data of a typical “standard” bypass valve and a “non-linear” bypass valve of the present invention. Specifically, this chart illustrates example data describing the “Flow” into the sprinkler 112 in gpm, and the “Time” needed for the nozzle base 114 to fully rotate in minutes. As the volume of water, i.e. the water flow, into the sprinkler 112 increases, the speed of the nozzle base 114 increases (i.e., the time for each revolution of the nozzle base 114 decreases). However, a comparison of the rotation times of a standard prior art bypass valve and the non-linear bypass valve of the present invention reveal less variation in the rotation speed of the non-linear bypass valve. For example, a standard bypass valve results in a complete rotation of the nozzle base in 3.83 minutes at a flow of 6 gpm as compared to 2.13 minutes at 30 gpm, thus creating a difference in rotation time of only 1.70 minutes. In comparison, the non-linear bypass valve results in a complete rotation of the nozzle base in 3.40 minutes at 6 gpm as compared to 2.30 minutes at 30 gpm, thus creating a difference in rotation time of only 1.10 minutes. In this respect, it can be seen that the rotation speed of the nozzle base 114 varies less with the non-linear bypass valve of the present invention than with the standard prior art bypass valve, and therefore provides a more even distribution of water to the surrounding turf.

To better illustrate the variations in speed differences between the prior art valve and the invention valve, FIG. 6B presents a graph of selected data from FIG. 6A. Specifically, the full rotation time of a nozzle base 114 is plotted against the water flow into the sprinkler 112 for both a standard prior art bypass valve and the non-linear increasing valve of the present invention. To better illustrate variations in the rotation speed, FIG. 6B also includes a standard valve comparative line and a non-linear increasing comparative line. Both of these comparative lines represent “best fit” lines for the standard and non-linear increasing valve data, providing a reference line to contrast the variations in rotation speed of each valve.

The final line of FIG. 6B, illustrates the rotational speed of an ideally optimized non-linear increasing valve of the present invention. Specifically, the non-linear increasing valve is optimally adjusted to nearly perfectly compensate for the spring constant of the valve spring.

FIG. 6B illustrates the variations in nozzle base rotation speed between the standard valve and the non-linear increasing valve of the present invention, as described in the discussion of FIG. 6A. The line depicting the rotation speed of the nozzle base of the standard valve is much steeper (higher slope) than the line depicting the rotation speed of the nozzle base of the non-linear increasing valve, meaning that the flow has a reduced effect on the rotation speed of the sprinkler with the invention valve. Thus, it can be seen that the non-linear increasing valve displays superior characteristics over the prior art valve.

As FIG. 6B also shows, the standard valve data not only has a greater slope (i.e. greater variation of rotation speed depending on the flow) but also may have more irregular variations in the rotation time on a smaller scale. Although such irregularities may not be prominently apparent in all bypass valve configurations, it is desirable to ensure that they are not present to create even water distribution. For example, at the flow data points of 14, 18, and 20 gpm the standard valve illustrates significant deviation from the linear standard valve comparative line, whereas the non-linear increasing valve illustrates minor deviation from the non-linear increasing comparative line at the same flow data points. Generally, this greater deviation of the standard valve illustrates the undesirable and irregular nature of the standard valve which, as previously discussed, can distribute water unevenly on the surrounding turf.

Ideally, a perfectly optimized non-linear increasing bypass valve produces a substantially horizontal line on the graph of FIG. 6B as seen by the Optimized Non-Linear Bypass Increasing Valve line. The speed of such a perfectly optimized valve remains substantially constant despite wide variations in the water flow entering the sprinkler since the spring constant is compensated for. Specifically, the scalloped protrusions 108a compensate for the spring constant of the stator spring 106 as previously discussed, thus maintaining a constant water flow to the turbine 122. With a constant turbine speed, the nozzle base 114 ultimately rotates at a substantially constant speed and therefore distributes an even amount of water to the surrounding turf.

In operation, water enters the sprinkler 112 through the inlet 103, passing first through a screen 120 to filter out debris. Initially the water flow moves through apertures 110a in the stator cover 110, through the flow passage 102a in the stator housing 102, and out apertures 104a in the flow director 104. The flow director 104 then directs this water flow towards the blades of the turbine 122, turning the turbine 122 in one direction or the other, depending on the position of the flow director 104. The turning turbine 122 drives the gears of gear assembly 116 which ultimately rotates the nozzle base 114.

When the water flow below the stator 100 increases to a predetermined water pressure, the stator bypass valve plunger 108 begins to move away from the aperture 110b of stator cover 110. As the stator bypass plunger 108 moves within the stator 100, the oblong openings 121 between the scalloped protrusions 108a open to allow a portion of the water to enter the aperture 110B and pass through the outer circumferential area of the stator housing 102. This bypass water flow 119 is directed around the turbine 122, avoiding the outer blades 122a of the turbine 122 and thus not providing further force to the mechanisms that rotate the nozzle base 114.

As the pressure from the water flow increases on the stator 100, the stator plunger 108 presses against the stator spring 106, causing the stator spring 106 to compress. As this occurs, the scalloped protrusions 108a allow an increasing yet compensated flow of water through the bypass path 119 in the stator 100. Thus, when the pressure from the water flow achieves a force powerful enough to unseat the stator plunger 108, the water flow to the blades 122a of the turbine 122 nevertheless remain relatively constant and therefore the rotational speed of the nozzle base 114 also remains relatively constant.

It should be understood that although each scalloped protrusion 108a shown in the present figures have curved or scalloped sides directed to a point, other shapes may be used, so long as these shapes at least partially compensate for the variable compression characteristics or spring constant of the stator spring 106. For example, the sides of scalloped protrusion may be linear instead of curved, forming a more traditional triangular shape. In another example, the sides of the scalloped protrusion may have a stepped pattern, forming a pyramid-like shape. In another example, the stator plunger may include a collar in place of the scalloped protrusions, having variously sized and shaped apertures to control the bypassed water flow. The amount of compensation required is inversely proportional to the ratio of the free length of the spring to the difference in the distance the spring is compressed between the fully open and fully closed positions of the stator plunger. Simply, the longer the spring is in its free state or the shorter the distance between the stator plunger's fully open and closed states, the higher the ratio and the less compensation is required.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A bypass stator for a rotatable irrigation sprinkler comprising:
a stator body having a first water flow passage and a second water flow passage;
a bypass valve disposed in said second water flow passage and configured to open when a water pressure achieves a predetermined value; said valve comprising:
a plunger;
a spring biasing said plunger to a closed position; and
a plurality of water bypass openings disposed along a longitudinal axis of said plunger, said openings increasing in size along said longitudinal axis so as to minimize a change in rotational speed of said irrigation sprinkler otherwise urged by an increase of water pressure in said stator body.

2. The bypass stator of claim 1, wherein said plunger has a circular shape and said water bypass openings are disposed on a circumference of said plunger.

3. The bypass stator of claim 2, wherein said water bypass openings are defined by a plurality of scalloped protrusions extending from a base of said plunger.

4. The bypass stator of claim 1, wherein said water bypass openings have an oblong shape that increases in size as said openings extend away from a base of said plunger.

5. The bypass stator of claim 1, wherein said water bypass openings have a substantially triangular shape.

6. The bypass stator of claim 1, wherein said increase in the size of said water bypass openings substantially compensates for a spring constant of said spring on said plunger.

7. The bypass stator of claim 1, wherein said water bypass openings are shaped to non-linearly increase flow through said second water flow passage as said water pressure increases.

8. A sprinkler for distributing water comprising:
a housing having an inlet;
a base rotatably mounted on said housing and having an outlet in fluid communication with said inlet;
a turbine disposed within said housing and operatively connected to said base for driving said base;
a stator assembly positioned within said housing between said inlet and said outlet;
said stator assembly having a first water flow passage for driving said turbine and a second water flow passage substantially bypassing said turbine;
a valve disposed in said stator assembly, said valve biased to prevent flow through said second flow passage until a predetermined pressure is exerted against said valve; and
a plurality of bypass openings disposed on said valve, said bypass openings shaped to increase flow through said second water flow passage as greater pressure is exerted against said valve such that a change in rotational speed of said base otherwise urged by an increase of water pressure is minimized.

9. The sprinkler of claim 8, wherein said valve has a circular shape and said bypass openings are disposed on a circumference of said valve.

10. The sprinkler of claim 9, wherein said bypass openings are defined by a plurality of scalloped protrusions extending from a base of said valve.

11. The sprinkler of claim 8, wherein said bypass openings have an oblong shape that increases in size as said openings extend away from a base of said valve.

12. The sprinkler of claim 8, wherein said bypass openings have a substantially triangular shape.

13. The sprinkler of claim 8, wherein bypass openings increase in the size so as to substantially compensate for a spring constant of a spring biasing said valve in a closed position.

14. The sprinkler of claim 8, wherein said bypass openings are shaped to non-linearly increase flow through said second water flow passage as said water pressure increases.

15. A method of regulating the rotational speed of a sprinkler comprising:
providing a sprinkler having a rotatable nozzle base directing water flow through a main flow path in said sprinkler to thereby cause rotation of said nozzle base;
directing a portion of said water flow away from said main flow path and through a bypass flow path when a water pressure equals a predetermined threshold pressure; and
non-linearly increasing an amount of water through said bypass flow path according to an increase in said water pressure beyond said threshold pressure so as to regulate a rotational speed of said nozzle base.

16. The method of claim 15, wherein non-linearly increasing the amount of water through said bypass flow path includes exposing said water flow to a plurality of bypass openings in said sprinkler.

17. The method of claim 16, wherein the exposing of said water flow to a plurality of bypass openings includes exposing said water flow to bypass openings that increase in size along an axis of said bypass flow path.

18. The method of claim 17, wherein the exposing of water flow to a plurality of bypass openings includes exposing said water flow to bypass openings that are defined by scalloped protrusions extending from a base of a bypass valve in said sprinkler.

19. The method of claim 17, wherein the exposing of water flow to a plurality of bypass openings includes exposing said water flow to bypass openings that are triangular in shape.

20. The method of claim 17, wherein the exposing of water flow to a plurality of bypass openings includes exposing said water flow to bypass openings that have an oblong shape.
